(19) United States
(12) Patent Application Publication
(10) Pub. No.: US 2006/0283798 A1
(43) Pub. Date: Dec. 21, 2006

(54) Method and apparatus for purifying a pigment dispersion, pigment dispersion, ink set, droplet-ejecting apparatus, and inkjet-recording ink tank

(75) Inventors: Hiroyuki Ueki, Kanagawa (JP); Ken Hashimoto, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/349,649

(22) Filed: Feb. 8, 2006

(30) Foreign Application Priority Data
Jun. 20, 2005 (JP) 2005-179888

(51) Int. Cl. B01D 11/04

(52) U.S. Cl. 210/634; 210/511; 118/600

(57) ABSTRACT

A method of purifying a pigment dispersion including: bringing an unpurified pigment dispersion containing a pigment and impurities into liquid-liquid interfacial contact with an extracting liquid in a microspace, and extracting and removing the impurities in the unpurified pigment dispersion into the extracting liquid to obtain a purified pigment dispersion. Further, an apparatus for purifying a pigment dispersion, a pigment dispersion and an ink set using the same, and a droplet-ejecting apparatus and an inkjet-recording ink tank using ink prepared by employing the pigment dispersion are provided.

### CROSS-REFERENCE TO RELATED APPLICATION

This application claims priority under 35 USC 119 from Japanese Patent Application No. 2005-179888, the disclosure of which is incorporated by reference herein.

### BACKGROUND OF THE INVENTION

1. Field of the Invention

The present invention relates to a method and an apparatus for purifying a pigment dispersion which is used in the production of an ink, and to a pigment dispersion and an ink set using the same. Further, the present invention also relates to a droplet-ejecting apparatus and an inkjet-recording ink tank using an ink prepared by using the pigment dispersion.

2. Description of the Related Art

Recently, surface-treated self-dispersible pigments and conventional hydrophobic pigments have been used as pigments for colorants in inks for use in ink-jet recording. When the conventional hydrophobic pigment is used, a pigment dispersant such as a resin dispersant or the like is additionally used for ensuring the dispersion stability of the pigment in the ink.

Such an ink is generally produced by adding various components to a dispersion containing a pigment dispersed in advance (hereinafter, referred to as “pigment dispersion for the production of an ink”). In a process of producing an ink, purification treatments such as filter filtration, ion exchange and the like are carried out for the removal of impurities such as particles and ionic substances contained in various raw material solutions including the pigment dispersion for the production of an ink (see, for example, JP-A No. 11-222573, the disclosure of which is incorporated by reference herein).

However, even when an ink prepared by using these purification treatments is used, ejection efficiency of the ink from a recording head and dispersion stability of the pigment in the ink are often insufficient, and thus, it is presumed that there are some impurities in the ink, which cannot be removed by these purification treatments, and which cause these problems.

### SUMMARY OF THE INVENTION

The inventors have intensively studied the kinds of impurities that are not removed by the conventional purification treatments. There are, of course, various particles in inks as in any liquid, and additionally, there are various kinds of ionic contamination, such as metal salts in the raw materials for the ink. However, these impurities can be removed by traditional filter filtration and ion exchange.

Thus, if improper ejection and deterioration in storage stability are caused by the impurities that are not removed, it was thought that these problems could be solved by repeatedly performing filter filtration and ion exchange or by improving the grade of these purification treatments. However, there were cases where the improper ejection and deterioration in storage stability could not be avoided even with these methods, and the inventors assumed that the impurities that are not basically removed by filter filtration and ion exchange were responsible for the improper ejection and the deterioration in storage stability.

Considering the raw materials for ink, a third group of impurities, which are difficult to remove by filter filtration and ion exchange, other than particles and ionic substances seemed to be mainly various organic materials in ink, such as a resin which is used as a dispersant for pigments, and low-molecular weight non-polar substances, such as dimers and the like, produced in the preparative process.

On the other hand, these low-molecular weight substances have a molecular size much smaller than that of the main ingredients (pigments, dispersant resins, and the like) which constitute the ink, other than solvent components. This means that the impurities have a diffusion speed that is much faster than that of the main ingredients. It would therefore be possible to remove the third impurities selectively and efficiently, by using the diffusion phenomenon of the substances in liquid in consideration of the properties of ink components.

Accordingly, the invention provides a method and an apparatus for purifying a pigment dispersion by removing impurities that could not be removed by conventional purification treatments, which are contained in the pigment dispersion such as the pigment dispersion for the production of ink, ink and the like; a pigment dispersion and an ink set using the same; and a droplet-ejecting apparatus and an inkjet-recording ink tank using the ink prepared by employing the pigment dispersion.

The present invention provides also an apparatus for purifying a pigment dispersion. The apparatus comprises: a purifying unit in which an unpurified pigment dispersion containing a pigment and impurities is brought into liquid-liquid interfacial contact with an extracting liquid in a microspace and the impurities in the unpurified pigment dispersion are extracted into the extracting liquid to remove the impurities, an unpurified pigment dispersion supplying unit that introduces the unpurified pigment dispersion, an extracting liquid supplying unit that introduces the extracting liquid, a pigment dispersion recovery unit that collects the pigment dispersion purified by the purifying unit, and an extracting liquid recovery unit that collects the extracting liquid containing the extracted impurities, from the purifying unit.

In addition, the present invention provides an apparatus for purifying a pigment dispersion, comprising: a purifying unit which comprises a first channel, a second channel, and a confluent zone in which a region of the first channel and a region of the second channel are connected to each other and a liquid stream in the first channel and a liquid stream in the second channel flow in a state of liquid-liquid interfacial contact, an unpurified pigment dispersion supplying unit that introduces an unpurified pigment dispersion containing a pigment and impurities into the first channel and that is connected thereto at an upstream side of the confluent zone, an extracting liquid supplying unit that introduces the extracting liquid into the second channel and that is connected thereto at an upstream side of the confluent zone, a pigment dispersion recovery unit that collects the pigment dispersion purified by the purifying unit and that is connected to the first channel at a downstream side of the confluent zone, and an extracting liquid recovery unit that collects the extracting liquid containing extracted impurities, from the purifying unit and that is connected to the second channel at a downstream side of the confluent zone.

### BRIEF DESCRIPTION OF DRAWINGS

FIG. 1 is a schematic view illustrating the configuration of an embodiment of the main region of a microreactor for use in the present invention;

FIG. 2 is a schematic view illustrating the configuration of an embodiment of a pigment dispersion-purifying apparatus having two microreactors connected to each other in series;

FIG. 3 is a perspective view illustrating the configuration of an exterior of a favorable embodiment of an inkjet-recording apparatus according to the present invention;

FIG. 4 is a perspective view illustrating the basic configuration of the interior of the inkjet-recording apparatus shown in FIG. 3;

FIG. 5 is a perspective view illustrating the exterior configuration of another favorable embodiment of the inkjet-recording apparatus according to the present invention; and

FIG. 6 is a perspective view illustrating the basic configuration of the interior of the inkjet-recording apparatus shown in FIG. 5.

### DETAILED DESCRIPTION OF THE INVENTION

(Method of Purifying a Pigment Dispersion)

The method of purifying a pigment dispersion according to the present invention comprises bringing an unpurified pigment dispersion containing a pigment and impurities into liquid-liquid interfacial contact with an extracting liquid in a microspace, and extracting and removing the impurities in the unpurified pigment dispersion into the extracting liquid to obtain a purified pigment dispersion.

Accordingly, an ink prepared by using a pigment dispersion prepared by the method of purifying a pigment dispersion according to the present invention does not contain impurities that were difficult to remove by conventional purification methods, and therefore allows prevention of deterioration in the storage stability of the ink, accumulation of impurities around the nozzle of a recording head in ink-jet recording during use, and improper ejection of the ink. It also prevents cogation in a recording head in a thermal process during ink-jet recording.

The “pigment dispersion” for use in the present invention means the entire liquid containing a dispersed pigment, and generally, an ink itself or a pigment dispersion for production of ink that contains other components added for adjustment of the ink. Thus, the method of purifying a pigment dispersion according to the present invention may be applied not only to a pigment dispersion for production of ink, which is used for adjustment of ink, but also to an ink that has been prepared by using the pigment dispersion for production of ink. Purification of the pigment dispersion for production of ink by the method of purifying a pigment dispersion according to the present invention, which leads to decrease in the viscosity after purification, also has an advantage in that the range of the allowable viscosity of ink is widened in preparation of the ink by using a pigment dispersion for production of ink after purification.

In addition, the term “unpurified” in the “unpurified pigment dispersion” in the specification (or in “unpurified pigment dispersion for the production of inks” and “unpurified ink”) simply means a state before the purification treatment to be used in the present invention as described above has been carried out. Accordingly, when a dispersion that has been subjected one time to the purification treatment used in the present invention, or a dispersion that has been subjected to another treatment such as filter filtration or ion exchange treatment, or a dispersion that has been subjected to any other purification treatments is used in further purification treatment using the purifying treatment of the present invention, a state before the purification treatment used in the present invention may be expressed using the term “unpurified” in the “unpurified pigment dispersion” as described above.

The pigment contained in the unpurified pigment dispersion is not particularly limited, but is preferably a self-dispersible pigment that can be dispersed as it is. If the pigment is not self-dispersible, the unpurified pigment dispersion preferably contains a dispersant for the pigment such as polymer dispersant (resin) or surfactant.

When a self-dispersible pigment is used as the pigment, unreacted materials originated in the process of preparing the self-dispersible pigment by surface treatment of hydrophobic pigment are contained in the unpurified pigment dispersion as impurities which are difficult to remove by filter filtration, ion exchange or the like. Further, when a pigment dispersant is used, polymer dispersant (resin), organic materials such as surfactant and by-products in the preparative process thereof are contained in the unpurified pigment dispersion as impurities which are difficult to remove by filter filtration, ion exchange or the like. However, it is possible to remove these impurities effectively by using the method of purifying a pigment dispersion according to the present invention.

When the unpurified pigment dispersion is a pigment dispersion for production of inks, the pigment content is preferably in the range of 3 to 50 weight by parts and more preferably in the range of 5 to 30 weight by parts.

A cheaper pigment containing a greater amount of impurities in the printing grade (having a higher oil adsorption and a greater primary particle diameter) may be used as a starting material, when an ink is produced by using the method of purifying a pigment dispersion according to the present invention. Even in such a case, it is possible to prepare an ink containing impurities in an amount fewer than that for the conventional cases, by purification in combination with filter filtration and/or ion exchange.

A pigment dispersion for preparation of inks containing a self-dispersible pigment may be prepared by purifying a crude pigment by the method of purifying a pigment dispersion according to the present invention, surface-treating the pigment after purification, and dispersing the pigment into a solvent; or a pigment dispersion for preparation of inks may be prepared by mixing a pigment after purification and a pigment dispersant and dispersing the mixture into a solvent.

The method of purifying a pigment dispersion according to the present invention is a purification method using diffusion phenomenon of substances through the liquid-liquid interface between an unpurified pigment dispersion and an extracting liquid, in which the main driving force of diffusion is induced by the difference in concentrations of substances. Thus, the extracting liquid is particularly preferably a liquid at least containing a smaller amount of the impurities to be removed; and a high-purity liquid is used generally. In such a case, the purity of the liquid for use as the extracting liquid is preferably 90% or more, more preferably 95% or more. The higher purity of the extracting liquid is more preferable.

The kind of the liquid for use as the extracting liquid is not particularly limited, and for example, liquids such as ultrapure water, various organic solvents, or mixtures of two or more solvents may be used, but liquids having a high solubility to the impurities to be removed are preferable. For prevention of reverse diffusion from the extracting liquid to unpurified pigment dispersion, the liquids which are used as the extracting liquid preferably has solubility to the impurities that is higher than that of the solvent for the unpurified pigment dispersion.

Although it is often difficult to identify the impurities to be removed strictly even with various analytical means, it is easier to estimate them by taking into consideration the various organic materials used in preparation of the pigment dispersion, the preparative process thereof, and the like. As described above, it is thus possible to select a liquid used as the extracting liquid properly depending on the kinds of impurities to be removed.

For example, when the impurities to be removed are a water-soluble substance, pure water or a water-soluble organic solvent may be used as the extracting liquid, and when the impurities to be removed are an oil-soluble substance, an oil-soluble organic solvent may be used as the extracting liquid.

Alternatively, when both water- and oil-soluble substances are contained as the impurities to be removed in the pigment dispersion, it is possible to use a mixture of solvents suitable for the respective substances as the extracting liquid. The dispersion may be purified by successive extraction using two or more extracting liquids, instead of using the mixture of two or more solvents as the extracting liquid.

The kind of the solvent for use as the extracting liquid depends on the impurities to be removed, but, for example, pure water, toluene, benzene, tetrahydrofuran, a dilute aqueous hydrochloric acid solution, a dilute aqueous sulfuric acid solution, an aqueous sodium hydroxide solution, or the like may be used.

The “microspace” in the present invention means a space surrounded by a wall having a maximum diameter of 10 mm or less in the direction orthogonal to the liquid-liquid interface formed by the contact between the unpurified pigment dispersion and the extracting liquid. The maximum diameter is preferably 5 mm or less, and more preferably 3 mm or less.

When the maximum diameter exceeds 10 mm, the distance for the impurities contained in the unpurified pigment dispersion at one side of the liquid-liquid interface to diffuse to the extracting liquid at the other side of the liquid-liquid interface is too long to remove sufficiently the impurities and the considerable time is required for removal of the impurities; and thus, it is unpractical.

However, the maximum diameter is preferably 0.5 mm or more, from the practical viewpoints of convenience in manufacturing the purification apparatus and processing amount per unit time.

The microspace may be a closed system suitable for batch processing, but an open system suitable for continuous processing is preferable. The shape of the microspace is not particularly limited, but, when the microspace is an open system, it is particularly preferably a minute cylindrical channel (hereinafter, referred to as “microchannel”) from a practical viewpoint. When the microspace is a microchannel, the maximum diameter in a direction that is orthogonal to the liquid-liquid interface represents the maximum diameter of the microchannel cross section.

On the other hand, the maximum length of the microspace in the direction parallel to the liquid-liquid interface (corresponding to the maximum length of microchannel) is not particularly limited, but preferably in the range of 10 to 200 mm from a practical viewpoint.

In an embodiment, the present invention uses a purification apparatus having such microspaces. The configuration of the purification apparatus is not particularly limited, and any configurations may be used if the method of purifying a pigment dispersion according to the present invention is applicable, but the following configuration is preferable.

The purification apparatus in the present invention preferably comprises at least a first channel, a second channel, and a confluent zone (corresponding to the microchannel described above) in which a region of the first channel and a region of the second channel are connected to each other and a liquid stream in the first channel and a liquid stream in the second channel flow confluently in a state of liquid-liquid interfacial contact with each other.

In such a case, an unpurified pigment dispersion is supplied into the first channel at an upstream side of the confluent zone, while an extracting liquid is supplied at an upstream side of the confluent zone in the second channel in the purification step.

In order to form a liquid-liquid interface between the unpurified pigment dispersion and the extracting liquid without mixing them each other, it is preferable that both the unpurified pigment dispersion and the extracting liquid form a substantially laminar flow in the confluent zone. For making both the unpurified pigment dispersion and the extracting liquid in the confluent zone flow substantially in the laminar flow state, it is preferable to adjust the size of the cross section in the confluent zone, the average cross-sectional speeds in the confluent zone, and the densities and the dynamic viscosities of the unpurified pigment dispersion and the extracting liquid flowing in the confluent zone to form the laminar flow, which are the factors governing the Reynolds number, an indicator of whether liquid is flowing in the laminar or turbulent flow state.

In an embodiment, the method of purifying a pigment dispersion according to the invention will be described specifically with reference to drawings below, in which so-called microreactor is used as one embodiment of a purifying unit in the purification apparatus according to the present invention for the sake of convenience.

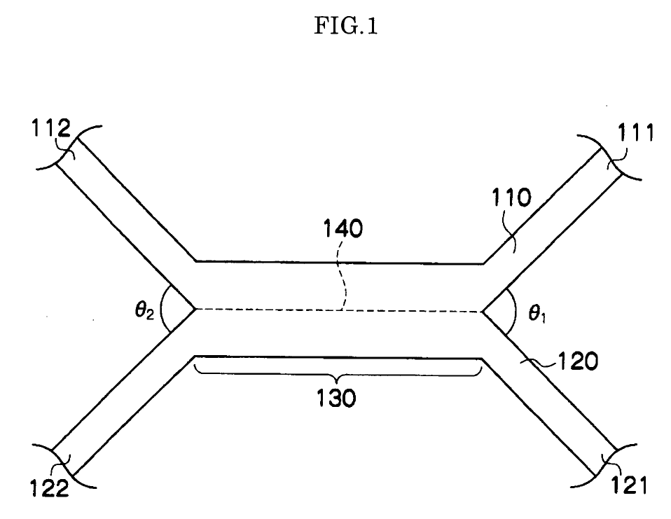

FIG. 1 is a schematic view illustrating the configuration of an embodiment of the main region of a microreactor for use in the present invention. In FIG. 1, 110 represents a first channel; 111 represents a liquid inflow side of the first channel 110; 112 represents a liquid outflow side of the first channel 110; 120 represents a second channel; 121 represents a liquid inflow side of the second channel 120; 122 represents a liquid outflow side of the second channel 120; 130 represents a confluent zone; and 140 represents a liquid-liquid interface.

The microreactor shown in FIG. 1 has a first channel 110, a second channel 120, and a confluent region 130 where these two channels are connected, and has a configuration in that the first channel 110 and the second channel 120 are connected to each other at angles of θ1 and θ2 at both ends of the confluent zone 130.

At an upstream side of the confluent zone 130, the liquid inflow side 111 of the first channel 110 is connected to an unpurified pigment dispersion supplying unit not shown in Figure, and the liquid inflow side 121 of the second channel 120 is connected to an extracting liquid supplying unit not shown in Figure. Further, at a downstream side of the confluent zone 130, the liquid outflow side 112 of the first channel 110 is connected to a purified pigment dispersion recover unit not shown in Figure, and the liquid outflow side 122 of the second channel 120 is connected to an extracting liquid recover unit not shown in Figure.

A filter and/or an ion-exchange resin may be provided as needed between the liquid inflow side 111 of the first channel 110 and the pigment dispersion supplying unit for removal of the particles and/or ionic substances in the pigment dispersion, and an ion-exchange resin or the like may be provided as needed between the liquid outflow side 112 of the first channel 110 and the purified pigment dispersion recover unit, for removal of the ionic substances in the pigment dispersion.

In the Figure, the sizes of the units constituting the microreactor are not particularly limited, if the crosswise direction width (the maximum diameter in the direction orthogonal to liquid-liquid interface 140) in the confluent zone 130 is in the range described above. The angles θ1 and θ2 between the first channel 110 and the second channel 120 branching at both ends of the confluent zone 130 may be approximately 30 to 150 degrees, and, for example, the cross-sectional shape of the first channel 110 and the second channel 120 may be square of 0.1 mm in height and 0.1 mm in width; the cross-sectional shape of the confluent zone 130, rectangular of 0.1 mm in height and 0.2 mm in width; the length of the confluent zone 130, 400 mm; and angles θ1 and θ2, both 90 degrees.

A pigment dispersion is purified by using an apparatus for purifying a pigment dispersion according to the present invention. In an embodiment, a microreactor shown in FIG. 1, which may be comprised as a purifying unit in the purification apparatus according to the present invention, may be used as follows:

First, an unpurified pigment dispersion is supplied from the liquid inflow side 111 of the first channel 110 connected to an unpurified pigment dispersion supplying unit not shown in Figure, and extracting liquid, for example, ultrapure water, is supplied from the liquid inflow side 121 of the second channel 120 connected to an extracting liquid supplying unit not shown in Figure. The flow rates of the pigment dispersion and ultrapure water then is preferable to be adjusted so that the unpurified pigment dispersion and ultrapure water in the confluent zone 130 flow in the laminar flow state in the confluent zone 130 to form a liquid-liquid interface 140 between them in the confluent zone 130 wherein two streams flow in the crosswise direction. Considering the processing amount per unit time, each of the flow rates is preferably in the range of approximately 0.1 to 50 ml/h.

By performing purification under such a condition, it is possible to collect a impurity-free purified pigment dispersion from the liquid outflow side 112 of the first channel 110 in a pigment dispersion recovery unit not shown in Figure. On the other hand, an ultrapure water containing the extracted impurities is discharged from the liquid outflow side 122 of the second channel 120 into an extracting liquid recovery unit not shown in Figure.

For quantitative monitoring of purity, determined are changes in the physical properties and the absorption spectra obtained by measuring the conductivity, UV spectrum, and others of the extracting liquids in the extracting liquid supplying unit and the extracting liquid recover unit.

Since the purification processing rate per microreactor is limited, it is preferable to connect multiple microreactors in parallel to one pigment dispersion supplying unit and one extracting liquid supplying unit, for ensuring a sufficiently high processing rate.

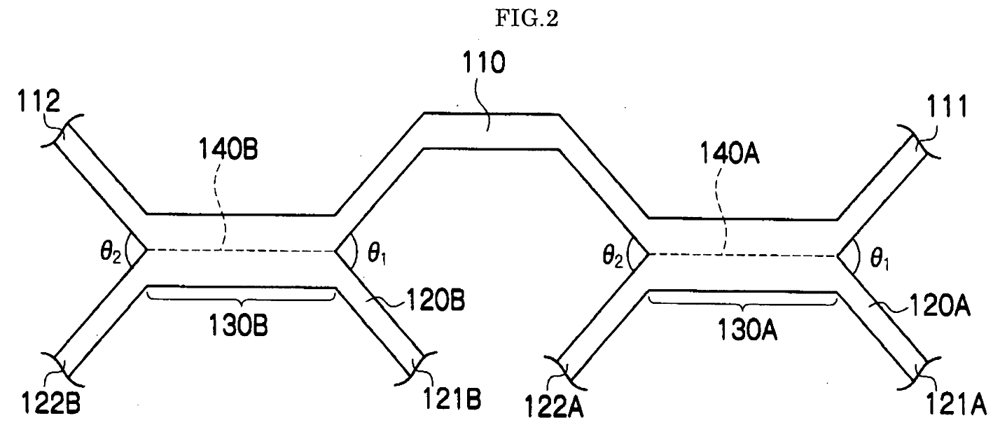

In another embodiment, the microreactors may be placed in series for obtaining higher purity. FIG. 2 is a schematic view illustrating the configuration of an embodiment of a pigment dispersion-purifying apparatus having two microreactors connected in series, and specifically, of that having two microreactors shown in FIG. 1 connected to each other in series.

In FIG. 2, 110 represents a first channel; 111 represents the liquid inflow side of the first channel 110; 112 represents the liquid outflow side of the first channel 110; 120A represents a second channel (for the first extracting liquid); 121A represents the liquid inflow side of the second channel 120A; 122A represents the liquid outflow side of the second channel 120A; 130A represents a confluent zone; 140A represents a liquid-liquid interface; 120 B represents a second channel (for the second extracting liquid); 121B represents the liquid inflow side of the second channel 120B; 122B represents the liquid outflow side of the second channel 120B; 130B represents a confluent zone; and 140B represents a liquid-liquid interface.

The pigment dispersion-purifying apparatus shown in FIG. 2 has a first channel 110, a second channel 120A (for the first extracting liquid), a second channel 120B (for the second extracting liquid), and confluent zones 130A and 130B where a liquid stream in the first channel 110 and a liquid stream in the second channels 120A and 120B are flowing concurrently, and has a configuration wherein a confluent zone 130A and another confluent zone 130B are placed at an upstream side and at a downstream side in the first channel 110 in the flow direction of the liquid flowing therein; and the first channel 110 and the second channel 120A are branched at both ends of the confluent zone 130A and the first channel 110 and the second channel 120B are branched at both ends of the confluent zone 130B.

At an upstream side of the confluent zone 1 30A, the liquid inflow side 111 of the first channel 110 is connected to an unpurified pigment dispersion-supplying unit not shown in Figure, while at a downstream side of the confluent region 130B, the liquid outflow side 112 of the first channel 110 is connected to a purified pigment dispersion recover unit not shown in Figure.

In addition, the liquid inflow side 121A of the second channel 120A is connected to a first extracting liquid-supplying unit (not shown in Figure) at an upstream side of the confluent zone 130A; the liquid outflow side 122A of the second channel 120A is connected to a first extracting liquid-recover unit (not shown in Figure) at a downstream side of the confluent zone 130A; the liquid inflow side 121B of the second channel 120B is connected to a second extracting liquid-supplying unit (not shown in Figure) at an upstream side of the confluent region 130B; and the liquid outflow side 122B of the second channel 120B is connected to a second extracting liquid-recover unit (not shown in Figure) at a downstream side of the confluent zone 130B.

It is possible to purify a pigment dispersion using the pigment dispersion-purifying apparatus shown in FIG. 2, by supplying an unpurified pigment dispersion from the liquid inflow side 111 of the first channel 110 connected to the unpurified pigment dispersion-supplying unit not shown in Figure, supplying a first extracting liquid from the liquid inflow side 121A of the second channel 120A connected to the first extracting liquid-supplying unit not shown in Figure, and supplying a second extracting liquid from the liquid inflow side 121B of the second channel 120B connected to the second extracting liquid-supplying unit not shown in Figure. The flow rate of each liquid then is so adjusted that the liquids in the confluent zones 130A and 130B flow in the laminar flow state in the confluent zones 130A and 130B to form liquid-liquid interfaces 140A and 140B in the confluent zones wherein two streams flow in the crosswise direction, in a similar manner to the microreactor shown in FIG. 1.

The first and second extracting liquids are selected properly depending on the kinds and amounts of the impurities to be removed in the unpurified pigment dispersion.

For example, when the impurities to be removed are mainly water-soluble substances and they are presented at a large amount, the dispersions are treated twice with pure water as the first and second extracting liquids. In such a case, the grade of the pure water used (for example, purity) may be different between the pure water for the first extracting liquid and the pure water for the second extracting liquid. In other words, if pure water lower in grade is used as the first extracting liquid for purification of the unpurified pigment dispersion which contains the impurities at a higher concentration and pure water higher in grade is used as the second extracting liquid for purification of unpurified pigment dispersion which contains the impurities at a lower concentration, it is possible to improve the purity efficiently while reducing the cost of the pure water used as the extracting liquid.

Further, when the impurities to be removed contain both water- and oil-soluble substances, pure water or the like may be used as one of the first or second extracting liquid for removal of water-soluble substances, while an oil-soluble solvent such as toluene, which are suitable for removal of oil-soluble substances may be used as the other extracting liquid. Thus, for removal of multiple kinds of impurities, it is possible to increase the purity further by changing the kind of the extracting liquid supplied to each of the confluent zones depending on the kinds of the impurities using a pigment dispersion-purifying apparatus having two or more microreactors connected to each other in series.

(Pigment Dispersion and Ink Set)

Hereinafter, a pigment dispersion and an ink set according to the present invention will be described. The pigment dispersion according to the invention includes pigment dispersions purified by the method of purifying a pigment dispersion according to the invention. When the composition of the purified pigment dispersion is a pigment dispersion for preparation of inks, other desirable components may be added to the composition for preparing inks, and when the composition is an ink itself, the composition may be used as it is in ink-jet recording.

In addition, the inks of two or more colors prepared by using the pigment dispersion purified by the method of purifying a pigment dispersion according to the invention may be used as an ink set in combination. In such a case, one color is particularly preferably black. The ink set may contain a processing solution containing a component accelerating aggregation of the pigments contained in inks of various colors for improvement in image density.

Hereinafter, components for the processing solution used in the ink, the ink set, or the like will be described in more detail.

The ink is not particularly limited, if it contains at least a pigment and a solvent such as water as described above, and the pigment may be a self-dispersible pigment; and a pigment dispersant may be added to facilitate dispersion of the pigment, and other components may be added thereto as needed. Although the materials that constitute an ink are not differentiated strictly from those that constitute a pigment dispersion for preparation of the ink, the pigment dispersion for preparation of inks contains essentially at least a pigment and a solvent such as water, and additionally a pigment dispersant when the pigment is not a self-dispersible pigment.

-Pigment-

Any of known pigments may be used as the pigment, and typical examples of black pigments include, but are not limited to, Raven 7000, Raven 5750, Raven 5250, Raven 5000 ULTRA II, Raven 3500, Raven 2000, Raven 1500, Raven 1250, Raven 1200, Raven 1190 ULTRA II, Raven 1170, Raven 1255, Raven 1080, and Raven 1060 (respectively manufactured by COLUMBIAN CARBON COMPANY); Regal 400R, Regal 330R, Regal 660R, Mogul L, Black Pearls L, Monarch 700, Monarch 800, Monarch 880, Monarch 900, Monarch 1000, Monarch 1100, Monarch 1300, and Monarch 1400 (respectively manufactured by Cabot Corporation); Color Black FW1, Color Black FW2, Color Black FW2 V, Color Black 18, Color Black FW200, Color Black S150, Color Black S160, Color Black S170, Printex 35, Printex U, Printex V, Printex 140U, Printex 140 V, Special Black 6, Special Black 5, Special Black 4A, and Special Black 4 (respectively manufactured by Degussa AG); and No. 25, No. 33, No. 40, No. 47, No. 52, No. 900, No. 2300, MCF-88, MA600, MA7, MA8, and MA100 (respectively manufactured by Mitsubishi Chemical Corporation).

Typical examples of cyan ink pigments include, but are not limited to, C.I. Pigment Blue-1, 2, 3, 15, 15:1, 15:2, 15:3, 15:4, 16, 22, 60, and the like.

Typical examples of magenta ink pigments include, but are not limited to, C.I. Pigment Red-5, 7, 12, 48, 48:1, 57, 112, 122, 123, 146, 168, 184, 202, and the like.

Typical examples of yellow ink pigments include, but are not limited to, C.I. Pigment Yellow-1, 2, 3, 12, 13, 14, 16, 17, 73, 74, 75, 83, 93, 95, 97, 98, 114, 128, 129, 138, 151, and 154, and the like.

In addition, examples of the self-dispersible pigments include pigments obtained by surface modification of the pigments above; commercially available self-dispersible pigments such as Cab-o-jet-200, Cab-o-jet-300, and IJX-55, manufactured by Cabot Corporation, Microjet Black CW-1 manufactured by Orient Chemical Industries, LTD, pigments available from NIPPON SHOKUBAI CO., LTD; and the like

The self-dispersible pigments are pigments self-dispersible in water that have multiple water-solubilizing groups on the pigment surface and that are dispersible stably in the absence of a polymer dispersant. The self-dispersible pigments are prepared, for example, by surface treatment, such as acid-base treatment, coupling agent treatment, polymer graft treatment, plasma treatment, or oxidation/reduction treatment, to pigments conventionally used.

The solubilizing group present on the surface of the self-dispersible pigment may be nonionic, cationic, or anionic; and in particular, a sulfonic acid, carboxylic acid, hydroxyl, or phosphoric acid group is favorable. When the solubilizing group is a sulfonic acid, carboxylic acid, or phosphoric acid group, the self-dispersing pigment is preferably used as a salt of a basic compound and the acidic groups for improvement in water-solubility, although may be used in a form of free acid itself. Examples of the basic compounds forming a salt with these acidic groups include alkali metals such as sodium, potassium, lithium, and the like; aliphatic amines such as monomethylamine, dimethylamine, triethylamine, and the like; alcohol amines such as monomethanol amine, monoethanolamine, diethanolamine, triethanolamine, diisopropanolamine, and the like; ammonia, and the like. Among them, basic compounds of alkali metals are strong electrolytes and have a greater potential of accelerating dissociation of acidic groups, and thus, use of an alkali metal such as sodium, potassium, or lithium is preferable.

The content of the pigment in an ink is preferably in the range of 3 to 15% by weight. A pigment content of less than 3% by weight may lead to insufficient image density. On the other hand, a content of more than 15% by weight may lead to inadequate dispersion of pigment and deterioration in the storage stability of ink.

-Dispersant for Pigments-

The polymer dispersants (resins) described above and the various surfactants described below may be used as dispersants for pigments which are used in dispersion of the pigment, and both of the polymer dispersants and the surfactants may be used in combination.

A polymer having both hydrophilic and hydrophobic structural regions is used effectively as the polymer dispersant. Examples of the polymers having hydrophilic and hydrophobic structural regions include condensation polymers and addition polymers. Typical examples of the condensation polymers include known polyester dispersants. Typical examples of the addition polymers include polymers produced from α,β-ethylenically unsaturated group-containing monomer, and the like. It is possible to obtain a desirable polymer dispersant, by copolymerizing α,β-ethylenically unsaturated group-containing monomer having a hydrophilic group and α,β-ethylenically unsaturated group-containing monomer having a hydrophobic group properly in combination. In addition, homopolymers of a monomer having α,β-ethylenically unsaturated group that has a hydrophilic group may also be used.

Examples of the α,β-ethylenically unsaturated group-containing monomers having a hydrophilic group include monomers having a carboxyl, sulfonic acid, hydroxyl, phosphoric acid group, or the like, such as acrylic acid, methacrylic acid, crotonic acid, itaconic acid, itaconic acid monoester, maleic acid, maleic acid monoester, fumaric acid, fumaric acid monoester, vinylsulfonic acid, styrenesulfonic acid, sulfonated vinylnaphthalene, vinyl acetate (raw material for polyvinylalcohol), acrylamide, methacryloxyethyl phosphate, bis methacryloxyethyl phosphate, methacryloxyethylphenyl acid phosphate, ethylene glycol dimethacrylate, diethylene glycol dimethacrylate, and the like.

Further, examples of the α,β-ethylenically unsaturated group-containing monomers having a hydrophobic group include styrene derivatives such as styrene, α-methylstyrene, and vinyltoluene, vinylcyclohexane, vinylnaphthalene, vinylnaphthalene derivatives, alkyl acrylate esters, phenyl acrylate ester, alkyl methacrylate esters, phenyl methacrylate ester, cycloalkyl methacrylate esters, alkyl crotonate esters, dialkyl itaconate esters, dialkyl maleate esters, and the like.

Preferable examples of the copolymers prepared from these monomers and others include styrene-styrenesulfonic acid copolymers, styrene-maleic acid copolymers, styrene-methacrylic acid copolymers, styrene-acrylic acid copolymers, vinylnaphthalene-maleic acid copolymers, vinylnaphthalene-methacrylic acid copolymers, vinylnaphthalene-acrylic acid copolymers, alkyl acrylate ester-acrylic acid copolymers, alkyl methacrylate ester-methacrylic acid copolymers, styrene-alkyl methacrylate ester-methacrylic acid copolymers, styrene-alkyl acrylate ester-acrylic acid copolymers, styrene-phenyl methacrylate ester-methacrylic acid copolymers, styrene-cyclohexyl methacrylate ester-methacrylic acid copolymers, styrene-methacrylic acid copolymers, and the like.

In addition, these copolymers may contain additionally a monomer having a polyoxyethylene or hydroxyl group as needed as a copolymerization component.

The copolymers may have any copolymer structures such as random coplymer, block copolymer, graft copolymer, or the like. In addition, polystyrenesulfonic acid, polyacrylic acid, polymethacrylic acid, polyvinylsulfonic acid, polyalginic acid, polyoxyethylene-polyoxypropylene-polyoxyethylene block copolymers, naphthalenesulfonic acid/formalin condensates, polyvinylpyrrolidone, polyethyleneimine, polyamines, polyamides, polyvinylimidazoline, aminoalkyl acrylate-acrylamide copolymers, chitosan, polyoxyethylene fatty acid amides, polyvinylalcohol, polyacrylamide, cellulose derivatives such as carboxymethylcellulose and carboxyethylcellulose, polysaccharides and derivatives thereof, and the like may also be used. At least one of the hydrophilic groups contained in the dispersant is preferably a carboxyl group.

In addition, the molecular weight (weight-average molecular weight expressed by a styrene as determined by GPC (gel permeation chromatography)) of the polymer dispersant is preferably in the range of 8,000 to 100,000. A molecular weight of less than 8,000 may lead to deterioration in the dispersion stability of pigment, while a molecular weight of more than 100,000 to increase in the viscosity of the ink and deterioration in ejection efficiency.

In measurement of the molecular weight, “HLC-8120GPC, SC-8020 (manufactured by Tosoh Corporation)” is used in the GPC analysis; two columns of TSK gel, Super HM-H (manufactured by Tosoh Corporation, 6.0 mmID×15 cm)” are used; and THF (tetrahydrofuran) was used as an eluant. As for the measuring conditions, the sample concentration is 0.5%: the flow rate is 0.6 ml/min, the sample injection amount is 10 μl; the measurement temperature is 40° C.; and the detector is an IR detector. A calibration curve is prepared by using 10 polystyrene standard samples, “TSK Standards” manufactured by Tosoh Corp.: “A-500”, “F-1”, “F-10, “F-80”, “F-380”, “A-2500”, F-4”, “F-4”, “F-128”, and “F-700”.

In addition, alkali metals such as Na, Li, or the like, organic amines such as triethanolamine, diethanolamine, or the like may be used as neutralizing agents during neutralization of the polymer dispersant, and two or more neutralizing agents may be used in combination.

-Other Additives-

The ink contains, in addition to the components above, water as a solvent and may further contain a water-soluble organic solvent. Addition of the water-soluble organic solvent to ink is effective in improving the water-retention efficiency of ink and processing solution, and the dispersability of the pigment in ink, preventing clogging and preserving the ejection stability when ink is ejected from a recording head, and avoiding aggregation/precipitation of the pigment and the surface-finishing agent contained in the processing solution during long-term preservation of inks.

Typical examples of the water-soluble organic solvents include polyvalent alcohols such as ethylene glycol, diethylene glycol, propylene glycol, butylene glycol, triethylene glycol, 1,5-pentanediol, 1,2,6-hexanetriol, glycerol and the like.

Examples of the glycol ethers include polyvalent alcohol derivatives such as ethylene glycol monomethylether, ethylene glycol monoethylether, ethylene glycol monobutylether, diethylene glycol monomethylether, diethylene glycol monoethylether, diethylene glycol monobutylether, propylene glycol monobutylether, dipropylene glycol monobutylether, ethylene oxide adducts of diglycerin, and the like.

Examples of the nitrogen-containing solvents include pyrrolidone, N-methyl-2-pyrrolidone, cyclohexylpyrrolidone, triethanolamine, and the like.

Examples of the sulfur-containing solvents include thiodiethanol, thiodiglycerol, sulfolane, dimethylsulfoxide, and the like. In addition, propylene carbonate, ethylene carbonate, or the like may be used in combination. An alcohol such as ethanol, isopropyl alcohol, butyl alcohol, or benzyl alcohol may also be used. The content of the water-soluble organic solvent used is 1 to 60% by weight, and preferably 5 to 40% by weight.

In addition, the ink may contain a surfactant. A compound having a structure of both hydrophilic and hydrophobic regions in the molecule may be used as the surfactant, and anionic surfactants, cationic surfactants, amphoteric surfactants, nonionic surfactants, or the like may be used.

Preferred examples of the anionic surfactants include alkylbenzenesulfonate salts, alkylphenylsulfonate salts, alkylnaphthalenesulfonate salts, higher fatty acid salts, sulfuric ester salts of a higher fatty acid ester, sulfonate salts of a higher fatty acid ester, sulfate ester and sulfonate salts of an higher alcohol ether, higher-alkyl sulfoscuccinate salts, higher-alkylphosphoric ester salts, phosphoric ester salts of a higher alcohol ethylene oxide adduct, and the like; and, for example, dodecylbenzenesulfonate salts, kellyl benzene sulfonate salts, isopropylnaphthalenesulfonate salts, monobutylphenylphenol monosulfonate salts, monobutylbiphenyl sulfonate salts, dibutylbiphenyl sulfonate salts, dibutylphenylphenol disulfonate salts, and the like.

Examples of the nonionic surfactants include polypropylene glycol ethylene oxide adducts, polyoxyethylene nonylphenylether, polyoxyethylene octylphenylether, polyoxyethylene dodecylphenylether, polyoxyethylene alkylethers, polyoxyethylene fatty acid esters, sorbitan fatty acid esters, polyoxyethylene sorbitan fatty acid esters, fatty acid alkylol amides, acetylene glycol, oxyethylene adducts of an acetylene glycol, aliphatic alkanol amides, glycerol esters, sorbitan esters, and the like.

Examples of the cationic surfactants include tetraalkylammonium salts, alkylamine salts, benzalkonium salts, alkylpyridinium salts, imidazolium salts, and the like; for example, dihydroxyethylstearylamine, 2-heptadecenyl-hydroxyethylimidazoline, lauryldimethylbenzylammonium chloride, cetylpyridinium chloride, stearamidomethylpyridium chloride, and the like.

In addition, silicone surfactants such as polysiloxane oxyethylene adducts, fluorine surfactants such as perfluoroalkyl carboxylate salts, perfluoroalkyl sulfonate salts, oxyethylene perfluoroalkylethers, or the like, bio-surfactant such as spiculisporic acid, rhamnolipids, lysolecithins, or the like are used favorably.

The addition amount of a surfactant to the ink is preferably less than 10% by weight. The addition amount of 10% by weight or more may lead to deterioration in image density and storage stability of the ink.

In addition, polyethyleneimine, polyamines, polyvinylpyrrolidone, polyethylene glycol, cellulose derivatives such as ethylcellulose, carboxymethylcellulose, or the like, polysaccharides or derivatives thereof, other water-soluble polymers, polymer emulsions such as acrylic polymer emulsion, polyurethane-based emulsion, or the like, cyclodextrin, macrocyclic amines, dendrimers, crown ethers, urea or derivatives thereof, acetamide, or the like may be used for the purpose of controlling properties, for example, for improvement in the ejection efficiency of inks.

In addition, an alkali metal compound such as potassium hydroxide, sodium hydroxide, or lithium hydroxide, a nitrogen-containing compound such as ammonium hydroxide, triethanolamine, diethanolamine, ethanolamine, or 2-amino-2-methyl-1-propanol, or the like may be used for control of conductivity and pH.

Further, other additives such as antioxidant, fungicide, viscosity adjuster, conductive substance, ultraviolet absorbent, or the like may be added as needed.

-Processing Solution-

A mixture which contains essentially no colorant component such as pigment, but contains at least a component (coagulant) aggregating the pigment in ink and a solvent such as water is used as a processing solution, and the mixture may contain other components as needed.

An inorganic electrolyte, an organic amine compound, an organic acid, or the like is used as a coagulant.

A pH adjuster, a polyvalent metal salt, or the like is used as an inorganic electrolyte. Specific examples of the pH adjuster include 2-pyrrolidone-5-carboxylic acid, 4-methyl-4-pentanolido-3-carboxylic acid, furancarboxylic acid, 2-benzofurancarboxylic acid, 5-methyl-2-furancarboxylic acid, 2,5-dimethyl-3-furancarboxylic acid, 2,5-furandicarboxylic acid, 4-butanolido-3-carboxylic acid, 3-hydroxy-4-pyrone-2,6-dicarboxylic acid, 2-pyrone-6-carboxylic acid, 4-pyrone-2-carboxylic acid, 5-hydroxy-4-pyrone-5-carboxylic acid, 4-pyrone-2,6-dicarboxylic acid, 3-hydroxy-4-pyrone-2,6-dicarboxylic acid, thiophenecarboxylic acid, 2-pyrrolecarboxylic acid, 2,3-dimethylpyrrole-4-carboxylic acid, 2,4,5-trimethylpyrrole-3-propionic acid, 3-hydroxy-2-indolecarboxylic acid, 2,5-dioxo-4-methyl-3-pyrroline-3-propionic acid, 2-pyrrolidinecarboxylic acid, 4-hydroxyproline, 1-methylpyrrolidine-2-carboxylic acid, 5-carboxy-1-methylpyrrolidine-2-acetic acid, 2-pyridinecarboxylic acid, 3-pyridinecarboxylic acid, 4-pyridinecarboxylic acid, pyridinedicarboxylic acid, pyridinetricarboxylic acid, pyridinepentacarboxylic acid, 1,2,5,6-tetrahydro-1-methylnicotinic acid, 2-quinolinecarboxylic acid, 4-quinolinecarboxylic acid, 2-phenyl-4-quinolinecarboxylic acid, 4-hydroxy-2-quinolinecarboxylic acid, 6-methoxy-4-quinolinecarboxylic acid, potassium hydrogen phthalate, potassium dihydrogen phosphate, boric acid, sodium citrate, potassium citrate, sodium tetraborate, tartaric acid, lactic acid, ammonium chloride, sodium hydroxide, potassium hydroxide, hydrochloric acid, derivatives and salts of these compounds, and the like.

Preferable are pyrrolidonecarboxylic acid, pyronecarboxylic acid, pyrrolecarboxylic acid, furancarboxylic acid, pyridinecarboxylic acid, coumarinic acid, thiophenecarboxylic acid, nicotinic acid, potassium dihydrogen citrate, succinic acid, tartaric acid, lactic acid, potassium hydrogen phthalate, and derivatives or salts of these compounds. More preferable are pyrrolidonecarboxylic acid, pyronecarboxylic acid, furancarboxylic acid, coumarinic acid, and derivatives or salts of these compounds.

Further, examples of the inorganic electrolytes include alkali metal ions such as lithium ion, sodium ion, and potassium ion; polyvalent metal ions such as aluminum ion, barium ion, calcium ion, copper ion, iron ion, magnesium ion, manganese ion, nickel ion, tin ion, titanium ion, and zinc ion; salts of hydrochloric acid, hydrobromic acid, hydroiodic acid, sulfuric acid, nitric acid, phosphoric acid, thiocyanic acid, organic carboxylic acids such as acetic acid, oxalic acid, lactic acid, fumaric acid, citric acid, salicylic acid, benzoic acid, and the like or organic sulfonic acids; and the like.

Typical examples thereof include alkali metal salts such as lithium chloride, sodium chloride, potassium chloride, sodium bromide, potassium bromide, sodium iodide, potassium iodide, sodium sulfate, potassium nitrate, sodium acetate, potassium oxalate, sodium citrate, and potassium benzoate; polyvalent metal salts such as aluminum chloride, aluminum bromide, aluminum sulfate, aluminum nitrate, sodium aluminum sulfate, potassium aluminum sulfate, aluminum acetate, barium chloride, barium bromide, barium iodide, barium oxide, barium nitrate, barium thiocyanate, calcium chloride, calcium bromide, calcium iodide, calcium nitrite, calcium nitrate, calcium dihydrogen phosphate, calcium thiocyanate, calcium benzoate, calcium acetate, calcium salicylate, calcium tartarate, calcium lactate, calcium fumarate, calcium citrate, copper chloride, copper bromide, copper sulfate, copper nitrate, copper acetate, iron chloride, iron bromide, iron iodide, iron sulfate, iron nitrate, iron oxalate, iron lactate, iron fumarate, iron citrate, magnesium chloride, magnesium bromide, magnesium iodide, magnesium sulfate, manganese nitrate, magnesium acetate, magnesium lactate, manganese chloride, manganese sulfate, manganese nitrate, magnesium dihydrogen phosphate, manganese acetate, manganese salicylate, manganese benzoate, manganese lactate, nickel chloride, nickel bromide, nickel sulfate, nickel nitrate, nickel acetate, tin sulfate, titanium chloride, zinc chloride, zinc bromide, zinc sulfate, zinc nitrate, zinc thiocyanate, and zinc acetate; and the like.

Examples of the organic amine compounds include primary, secondary, tertiary and quaternary amines, the salts of these amines, and the like. Typical examples thereof include tetraalkylammonium salts, alkylamine salts, benzalkonium salts, alkylpyridinium salts, imidazolium salts, polyamines, and the like; and more specific examples thereof include isopropylamine, isobutylamine, t-butylamine, 2-ethylhexylamine, nonylamine, dipropylamine, diethylamine, trimethylamine, triethylamine, dimethylpropylamine, ethylenediamine, propylenediamine, hexamethylenediamine, diethylenetriamine, tetraethylenepentamine, diethanolamine, diethylethanolamine, triethanolamine, tetramethylammonium chloride, tetraethylammonium bromide, dihydroxyethylstearylamine, 2-heptadecenyl-hydroxyethylimidazoline, lauryldimethylbenzylammonium chloride, cetylpyridinium chloride, stearamidomethylpyridium chloride, diallyldimethylammonium chloride polymers, diallyamine polymers, monoallylamine polymers, and the sulfonium salts, onium salts such as phosphonium salts, and phosphoric acid esters of these compounds, and the like.

Examples of the organic acids include the styrene-styrenesulfonic acid copolymers, styrene-maleic acid copolymers, styrene-methacrylic acid copolymers, styrene-acrylic acid copolymers, vinylnaphthalene-maleic acid copolymers, vinylnaphthalene-methacrylic acid copolymers, vinylnaphthalene-acrylic acid copolymers, alkyl acrylate ester-acrylic acid copolymers, alkyl methacrylate ester-methacrylic acid copolymers, styrene-alkyl methacrylate ester-methacrylic acid copolymers, styrene-alkyl acrylate ester-acrylic acid copolymers, styrene-phenyl methacrylate ester-methacrylic acid copolymers, styrene-cyclohexyl methacrylate ester-methacrylic acid copolymers, and the like.

In the invention, a coagulant may be used alone or two or more coagulants may be mixed and used in combination. The amount of the coagulant added to the processing solution is preferably 0.01% by weight to 30% by weight, more preferably 0.1% by weight to 15% by weight, and still more preferably 0.25% by weight to 10% by weight. When the addition amount of the coagulant is less than 0.01% by weight in the processing solution, it may lead to insufficient aggregation of pigment when ink and the processing solution are brought into contact on the recording medium and deterioration in image density and worsening of ink bleeding and intercolor ink bleeding, while an addition amount of more than 30% by weight may lead to deterioration in ejection property and improper ejection of the liquid.

On the other hand, a solvent may be the same solvent as that used in the ink, and other components may also be same components as those used in the ink as needed for obtaining desirable physical properties such as viscosity and surface tension.

-Physical Properties of Ink and Processing Solution-

A surface tension of the ink is preferably 20 mN/m to 60 mN/m, more preferably 20 mN to 45 mN/m, and still more preferably 25 mN/m to 35 mN/m. The surface tension of less than 20 mN/m may result in flooding of liquid on the nozzle face of recording head and prohibit normal printing. On the other hand, the surface tension of more than 60 mN/m may lead to deterioration in the permeability of ink and elongation of the drying period.

Viscosity of the ink is preferably 1.2 m Pa·s to 8.0 m Pa·s, more preferably 1.5 m Pa·s to 6.0 m Pa·s, and still more preferably 1.8 m Pa·s to 4.5 m Pa·s. The ink viscosity of more than 8.0 m Pa·s may result in deterioration in ejection efficiency, while an ink viscosity of less than 1.2 m Pa·s may result in deterioration of long-term ejection efficiency.

When an ink set according to the invention is a combination of inks and a processing solution, the preferable pH values of the inks and the processing solution are as follows:

When the inks are alkaline and the processing solution is acidic, the pH of the inks is preferably 7.5 to 10.5 and the pH of the processing solution is 2.5 to 7.0. On the other hand, when the inks are acidic and the processing is alkaline, the pH of the inks is preferably 2.5 to 7.0, while the pH of the processing solution is 7.5 to 10.5. More preferably, the pH of the alkaline liquid is 7.5 to 10.0, and still more preferably 8.0 to 9.5. On the other hand, the pH of the acidic liquid is preferably in the range of 3.0 to 7.0, and still more preferably 3.5 to 6.0.

An acidic liquid having a pH of less than 2.5 may dissolve the ink channel region of recording head, thereby causing malfunction of the recording head. Further, the pH of the acidic liquid exceeds 7.0, it may lead to insufficient aggregation of pigment when the ink and the processing solution are brought into contact with each other on a recording medium, resulting in deterioration in image density and worsening of ink bleeding and intercolor ink bleeding.

An alkaline liquid having a pH of less than 7.5 may lead to deterioration in the long-term ejection efficiency of the liquid, while that having a pH of more than 10.5 may lead to dissolution of the ink channel region of recording head and thus, to malfunction of the recording head.

The surface tension of the processing solution usable in the ink set is preferably 20 mN/m to 45 mN/m, more preferably 20 mN to 39 mN/m, still more preferably 25 mN/m to 35 mN/m. The surface tension of less than 20 mN/m may result in flooding of liquid on the nozzle face of recording head and prohibit normal printing. Alternatively, the surface tension of more than 45 mN/m may lead to deterioration in the permeability of ink and elongation of the drying period.

The viscosity of the processing solution is preferably 1.2 m Pa·s to 8.0 m Pa·s, more preferably 1.5 m Pa·s to 6.0 m Pa·s, and still more preferably 1.8 m Pa·s to 4.5 m Pa·s. When the viscosity of the first solution or the processing solution is more than 8.0 m Pa·s, the solution may have a lower ejection efficiency, while the viscosity of less than 1.2 m Pa·s may lead to deterioration in long-term ejection efficiency.

(Droplet-Ejecting Apparatus)

Hereinafter, a droplet-ejecting apparatus using an ink or ink set prepared by using a pigment dispersion of the present invention will be described.

The droplet-ejecting apparatus according to the invention comprises at least a droplet-ejecting unit that ejects droplets, and which forms an image by ejecting ink droplets onto a surface of a recording medium from the droplet-ejecting unit. In the droplet-ejecting apparatus, an ink is prepared by using a pigment dispersion according to the invention, and when an ink set comprising inks of two or more colors is used, the ink set according to the invention can be used. When an ink set of the present invention, which contains further a processing solution, is used, the droplet-ejecting apparatus according to the invention can form an image by ejecting ink droplets and processing solution droplets from the droplet-ejecting unit onto a surface of the recording medium being allowed to contact each other.

The droplet-ejecting unit may be droplet-ejecting units in the so-called piezoelectric process that ejects the droplets by application of a pressure to the droplets, or in the so-called thermal process that ejects droplets by application of a heat to the droplet.

The droplet-ejecting apparatus according to the invention is particularly preferably an inkjet-recording apparatus that may be used in office or at home, but may also be used in industrial applications. The following description is based on an assumption that the droplet-ejecting apparatus according to the invention is an inkjet-recording apparatus and the droplet-ejecting means is a recording head installed in the inkjet-recording apparatus.

The inkjet-recording apparatus according to the invention may have an inkjet-recording ink tank (hereinafter, referred to as “ink tank”) which is detachably connected to an inkjet-recording apparatus having a recording head, and supplies the inks and a processing solution to the recording head. The ink set according to the invention may be contained in the ink tank.

The inkjet-recording apparatus according to the invention can be used as a conventional inkjet-recording apparatus that uses inks or an ink set prepared by using the pigment dispersion according to the invention, or alternatively, may have an additional heater or the like for controlling ink drying as needed, an intermediate transfer mechanism of ejecting (prints) the ink and the processing solution onto an intermediate carrier body, and a transfer mechanism of retransferring the image formed thereon to a recording medium such as paper.

The ink tank is detachably connected to the inkjet-recording apparatus having a recording head, and any one of known ink tanks may be used, if it can supply an ink (and a processing solution) to the recording head in a state of being connected to the inkjet-recording apparatus. The ink or the ink set prepared by using the pigment dispersion according to the invention is stored in the ink tank.

When an ink set including a processing solution is used in the inkjet-recording apparatus according to the invention, the ratio of the ink amount per unit area applied on the recording medium surface to that of the processing solution (amount of ink ejected: amount of processing solution ejected) is preferably in the range of 1.2:1 to 20:1 by weight.

Although the ratio of the amount of the ejected processing solution to the amount of the ejected ink of lower than the range of 1.2:1 is advantageous in preventing troubles such as curl and cockle, an excessively lower rate reduces the advantageous effects of the processing solution, occasionally resulting in deterioration in image density and image resolution. On the other hand, the ratio of the amount of ejected processing solution of higher than the range of 20:1 may lead to more frequent generation of curl and cockle, although the image density and the image definition are favorable. The ratio is more preferable in the range of 1:16 to 1:2 and still more preferably in the range of 1:10 to 1:3.

In the inkjet-recording apparatus according to the invention, the weight of the liquid per one drop of the ink (and the processing solution) is preferably 25 ng or less, more preferably, 0.5 ng to 20 ng, and still more preferably 2 ng to 8 ng. The weight of the liquid per one drop of more than 25 ng may lead to worsening of ink bleeding. It is because the contact angle of the ink (and the processing solution) to the recording medium changes depending on the drop amount, and a drop tends to spread more over a paper in the surface direction when the drop amount increases.

In an inkjet apparatus ejecting multiple droplets different in volume from one nozzle, the drop amount refers to as the minimum amount of droplet allowing printing.

In addition, in ink-jet recording by using an ink set including a processing solution, the ink and the processing solutions are applied on a recording medium so as to bring into contact with each other, and the ink and the processing solution may be ejected either close to each other or overlapped, only if they become in contact with each other.

The order of ejection of the ink and the processing solution onto the recording medium is not particularly limited, and either of them may be applied first or both solutions may be applied at the same time; but they are preferably applied on the recording medium in the order of the processing solution and the inkjet ink. Prior application of the processing solution enables more effective aggregation of the colorants in the inkjet ink. The inkjet ink may be applied anytime after application of the processing solution. Preferably, the ink is applied within 1 second, more preferably 0.5 second or less, after application of the processing solution.

In the inkjet-recording apparatus according to the invention, the inks (and the processing solution) are preferably replenished (supplied) to the recording head from the respective ink tanks (including a processing solution tank) filled with inks (and a processing solution). The ink tanks are preferably detachable from the main apparatus, and the inks and the processing solution are replenished more easily when the ink tanks are exchanged as cartridge system.

Hereinafter, favorable embodiments of the inkjet-recording apparatus according to the invention will be described in detail with reference to drawings. In the Figures, the same codes are allocated to the units having essentially the same functions, and thus, duplicated description is avoided.

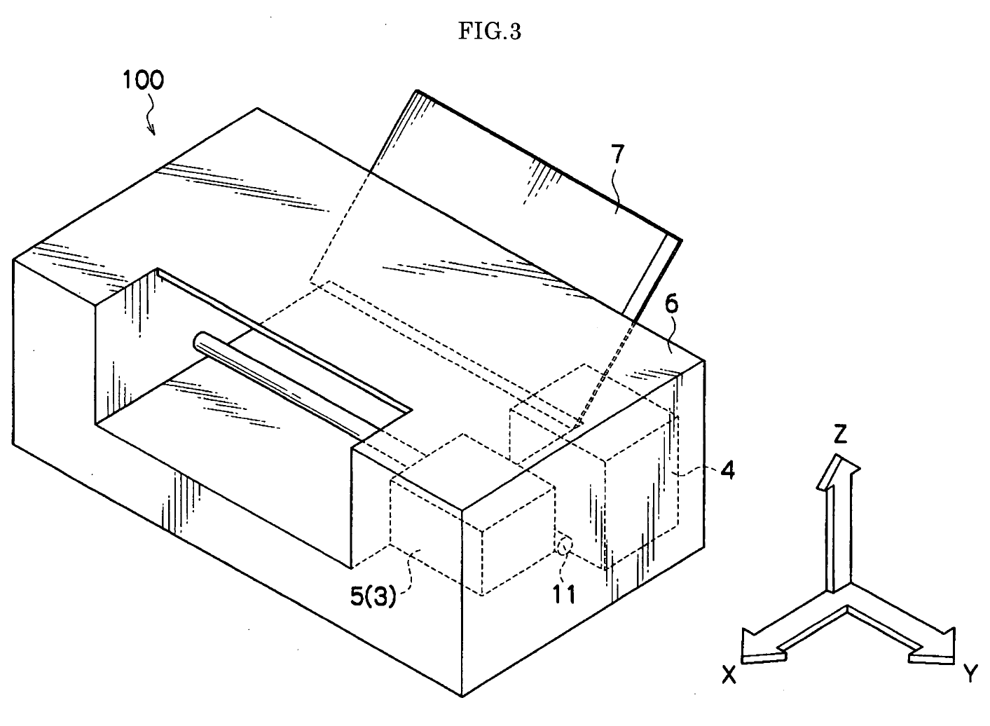

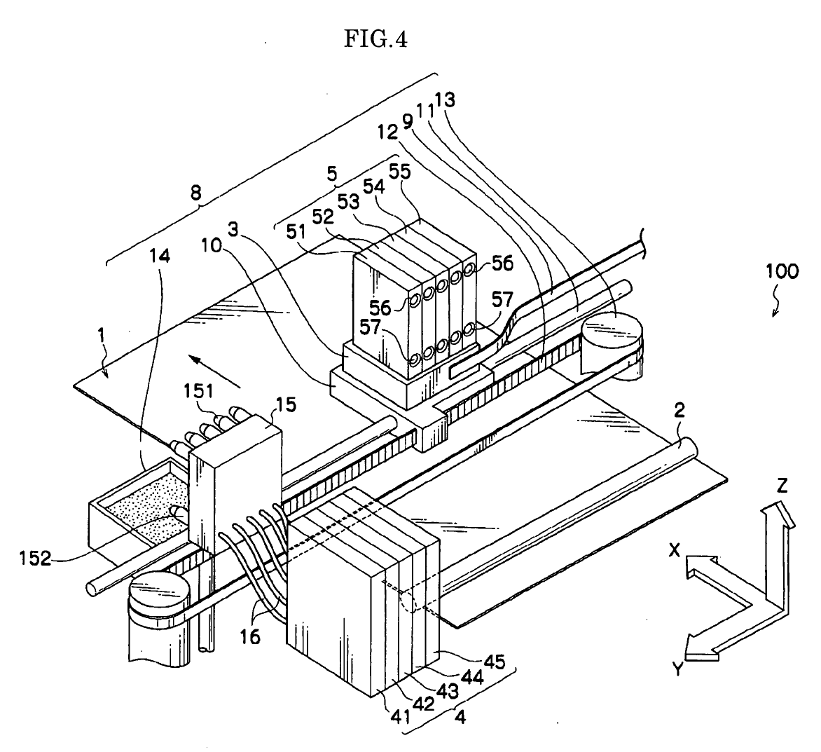

FIG. 3 is a perspective view illustrating the configuration of an exterior of a favorable embodiment of an inkjet-recording apparatus according to the invention. FIG. 4 is a perspective view illustrating the basic configuration of the interior of the inkjet-recording apparatus (hereinafter, referred to as image-forming apparatus) shown in FIG. 3.

In an embodiment, an image-forming apparatus 100 has a configuration in which an image is formed by operations based on the inkjet-recording method according to the invention described above. As shown in FIGS. 3 and 4, the image-forming apparatus 100 mainly has an outside cover 6, a tray 7 carrying a particular amount of a recording medium 1 such as plain paper, a conveyor roller (conveying unit) 2 of conveying the recording medium 1 one by one into the image-forming apparatus 100, an image-forming part 8 (image-forming unit) of forming an image by ejecting inks and a processing solution onto the surface of the recording medium 1, and a main ink tank 4 of supplying inks and a processing solution to a sub-ink tank 5 in the image-forming unit 8 therefrom.

The conveyor roller 2 is a paper-feeding mechanism consisting of a pair of rotatable rollers that is installed in the image-forming apparatus 100, which holds a recording medium 1 stored in the tray 7 and convey a particular amount of the recording media I at a particular timing one by one into the image-forming apparatus 100.

The image-forming part 8 forms an ink image on the surface of the recording medium 1. The image-forming part 8 mainly has a recording head 3, a sub-ink tank 5, a power/signal cable 9, a carriage 10, a guide rod 11, a timing belt 12, drive pulleys 13, and a maintenance unit 14.

The sub-ink tank 5 has sub-ink tanks 51, 52, 53, 54, and 55 respectively receiving inks different in color and a processing solution for ejection from the recording head. For example, four inks in different color, black ink (K), yellow ink (Y), magenta ink (M), and cyan ink (C), and a processing solution are fed from the main ink tank 4 and filled in respective sub-ink tanks.

Each of the sub-ink tanks 51 to 55 has an exhaust vent 56 and a replenishing hole 57. When the recording head 3 moves to a stand-by position (or replenishing position), a ventilation pin 151 and a replenishing pin 152 in a replenishing apparatus 15 are joined and connected to the exhaust vent 56 and the replenishing hole 57, and thus, the entire sub-ink tank 5 and the replenishing apparatus 15 are joined and connected to each other. The replenishing apparatus 15 is also connected to the main ink tank 4 via replenishing tubes 16, and the inks and the processing solution are replenished by the replenishing apparatus 15 from the main ink tank 4 through the replenishing holes 57 to the sub-ink tank 5.

The main ink tank 4 also has main ink tanks 41, 42, 43, 44, and 45 respectively storing inks different in color and a processing solution. For example, as the first liquids, black ink (K), yellow ink (Y), magenta ink (M) and cyan ink (C), and as the second liquid, a processing solution are filled respectively therein, and these main ink tanks respectively are detachably installed in the image-forming apparatus 100.

In addition, a power supply/signal cable 9 and the sub-ink tank 5 are connected to recording head 3, and when external recording image information is inputted through the power supply/signal cable 9 to the recording head 3, the recording head 3 withdraws a particular amount of ink from each sub-ink tank 5 and ejects it on the surface of recording medium based on the recording image information. The power supply/signal cable 9 also has a role of supplying power needed for driving the recording head 3 to the recording head 3, in addition to the recording image information.

The recording head 3 is placed and held on the carriage 10, and a guide rod 11 and a timing belt 12 supported by drive pulleys 13 are connected to the carriage 10. In such a configuration, the recording head 3 can move along the guide rod 11 in the direction parallel to the surface of the recording medium 1 and in the direction Y (main scanning direction) perpendicular to the conveyor direction X (secondary scanning direction) of the recording medium 1.

The image-forming apparatus 100 has control means (not shown in the Figure) of determining the timing of driving the recording head 3 and carriage 10 based on the recording image information. In this manner, it is possible to form continuously an image in a particular region on the surface of the recording medium 1 traveling in the conveyor direction X at a particular speed, based on the recording image information.

A maintenance unit 14 is connected to a pressure reducing device (not shown in the Figure) via a tube. In addition, the maintenance unit 14 is connected to the nozzle region of the recording head 3, and plays a role of withdrawing ink from the nozzle of the recording head 3 by bringing the nozzle of recording head 3 into a reduced-pressure state. By installation of the maintenance unit 14, it becomes possible to remove the undesirable ink deposited on the nozzle during operation of the image-forming apparatus 100 and reduce vaporization of ink from nozzles in the stand-by mode as needed.

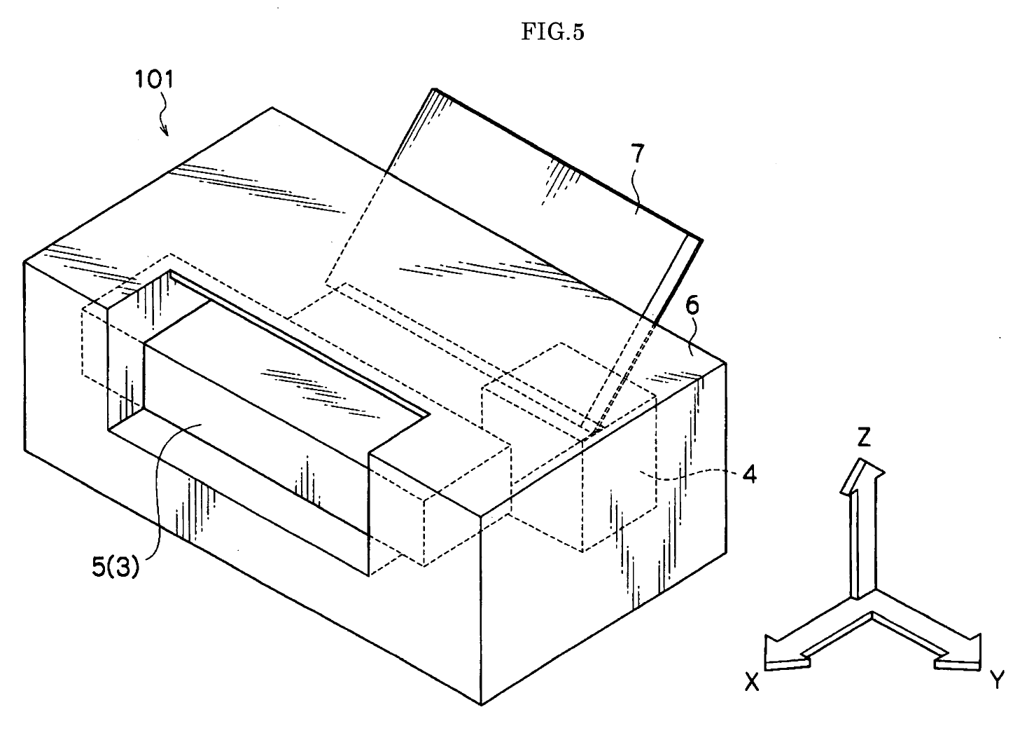

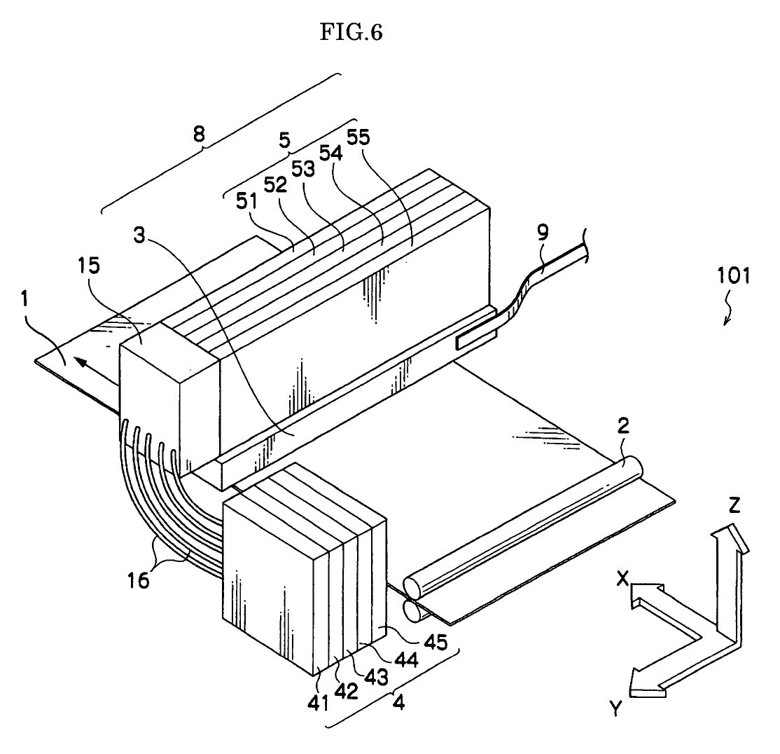

FIG. 5 is a perspective view illustrating the exterior configuration of another favorable embodiment of the inkjet-recording apparatus according to the invention. FIG. 6 is a perspective view illustrating the basic configuration of the interior of the inkjet-recording apparatus (hereinafter, referred to as image-forming apparatus) shown in FIG. 5. In an embodiment, an image-forming apparatus 101 has a configuration in which an image is formed by operation based on the inkjet-recording method according to the invention described above.

The image-forming apparatus 101 shown in FIGS. 5 and 6 has a recording head 3 having the same width as or larger than that of the recording medium 1, but does not have a carriage mechanism, and has a paper-feeding mechanism in the secondary scanning direction (conveyor direction of recording medium 1, indicated by arrow X); and, for example, a belt-shaped paper-feeding mechanism may be used instead of the conveyor roller 2 shown in this embodiment.

Although not shown in the Figure, nozzles ejecting inks of various colors (including a processing solution) are placed sequentially in the secondary scanning direction, together with sub-ink tanks 51 to 55 sequentially arranged in the secondary scanning direction (conveyor direction of recording medium 1, indicated by arrow X). Other configuration is the same as that of the image-forming apparatus 100 shown in FIGS. 3 and 2, and description thereof is omitted. Although the sub-ink tank 5 is shown in the Figure as it is always connected to a replenishing apparatus 15 because the recording head 3 does not move, the tank may be connected to the replenishing apparatus 15 only when the inks are replenished.

In the image-forming apparatus 101 shown in FIGS. 5 and 6, printing in the width direction of the recording medium 1 (main scanning direction) is performed all at once by the recording head 3, and thus, the apparatus is simpler in structure than those having a carriage mechanism and faster in printing speed.

Hereinafter, particularly preferable modes of the invention are listed. However, the invention is not necessarily limited to these modes.

(1) A method of purifying a pigment dispersion, comprising: bringing an unpurified pigment dispersion containing a pigment and impurities into liquid-liquid interfacial contact with an extracting liquid in a microspace, and extracting and removing the impurities in the unpurified pigment dispersion into the extracting liquid to obtain a purified pigment dispersion.

(2) The method of purifying a pigment dispersion of the above (1), wherein the pigment is a self-dispersible pigment.

(3) The method of purifying a pigment dispersion of the above (1), wherein the unpurified pigment dispersion comprises a dispersant for a pigment.

(4) The method of purifying a pigment dispersion of the above (1), wherein an apparatus for purifying a pigment dispersion which comprises at least a first channel, a second channel, and a confluent zone in which a region of the first channel and a region of the second channel are connected to each other and a liquid stream in the first channel and a liquid stream in the second channel flow in a state of liquid-liquid interfacial contact with each other is used, and the unpurified pigment dispersion is supplied to the first channel at an upstream side of the confluent zone and the extracting liquid is supplied to the second channel at an upstream side of the confluent zone.

(5) A pigment dispersion, prepared by the purifying method of the above (1).

(6) An ink set comprising inks of two or more colors including a black ink, wherein the inks are prepared with a pigment dispersion obtained by the purifying method of the above (1).

(7) A droplet-ejecting apparatus, which comprises at least a droplet-ejecting unit that ejects droplets, and which forms an image by ejecting ink droplets onto a surface of a recoding medium from the droplet-ejecting unit, wherein the ink is prepared by using a pigment dispersion prepared by the purifying method of the above (1).

(8) An inkjet-recording ink tank, which is detachably connected to an inkjet-recording apparatus having a recording head, stores an ink prepared by using a pigment dispersion prepared by the purifying method of the above (1), and supplies the ink to the recording head in a state of being connected to the inkjet-recording apparatus.

(9) An apparatus for purifying a pigment dispersion comprising:

a purifying unit in which an unpurified pigment dispersion containing a pigment and impurities is brought into liquid-liquid interfacial contact with an extracting liquid in a microspace and the impurities in the unpurified pigment dispersion are extracted into the extracting liquid to remove the impurities,

an unpurified pigment dispersion supplying unit that introduces the unpurified pigment dispersion,

an extracting liquid supplying unit that introduces the extracting liquid,

a pigment dispersion recovery unit that collects the pigment dispersion purified by the purifying unit, and

an extracting liquid recovery unit that collects the extracting liquid containing the extracted impurity, from the purifying unit.

(10) An apparatus for purifying a pigment dispersion comprising:

a purifying unit which comprises a first channel, a second channel, and a confluent zone in which a region of the first channel and a region of the second channel are connected to each other and a liquid stream in the first channel and a liquid stream in the second channel flow in a state of liquid-liquid interfacial contact,

an unpurified pigment dispersion supplying unit that introduces an unpurified pigment dispersion containing a pigment and impurities into the first channel and that is connected thereto at an upstream side of the confluent zone,

an extracting liquid supplying unit that introduces the extracting liquid into the second channel and that is connected thereto at an upstream side of the confluent zone,

a pigment dispersion recovery unit that collects the pigment dispersion purified by the purifying unit and that is connected to the first channel at a downstream side of the confluent zone, and

an extracting liquid recovery unit that collects the extracting liquid containing the extracted impurities, from the purifying unit and that is connected to the second channel at a downstream side of the confluent zone.

(11) The apparatus for purifying a pigment dispersion of the above (9) or (10), wherein a plurality of the purifying units are provided and are arranged in parallel or in series.

(12) The apparatus for purifying a pigment dispersion of the above (9) or (10), wherein the pigment is a self-dispersible pigment.

(13) The apparatus for purifying a pigment dispersion of the above (9) or (10), wherein the unpurified pigment dispersion includes a dispersant for the pigment.

(14) The apparatus for purifying a pigment dispersion of the above (9) or (10), wherein the unpurified pigment dispersion and the extracting liquid form a laminar flow in the confluent zone.

(15) The apparatus for purifying a pigment dispersion of the above (9) or (10), further comprising a filter and/or a unit that remove(s) particles and/or ionic contamination in the pigment dispersion and that is provided between the upstream side of the first channel and the unpurified pigment dispersion supplying unit that introduces the pigment dispersion.

Hereinafter, the present invention will be described with reference to Examples, but is not limited thereto.

### EXAMPLES

### Example 1

An unpurified pigment dispersion for preparation of inks is prepared by dissolving a self-dispersible pigment Cab-O-Jet 300 (manufactured by Cabot Corporation) in an ion-exchange water to be a solid matter concentration of 10 wt %. The unpurified pigment dispersion for preparation of inks is filtered in advance through a filter having an opening of 5 μm, for removal of impurity particles.

Then, the unpurified pigment dispersion for preparation of inks is purified by using an apparatus for purifying a pigment dispersion of which the configuration is shown in FIG. 1. In apparatus for purifying a pigment dispersion used, the first channel 110 and the second channel 120 have a square cross-sectional shape of 0.1 mm in height and 0.1 mm in width; the confluent zone 130 has a rectangular cross-sectional shape of 0.1 mm in height and 0.2 mm in width and a length of 400 mm; and the angles θ1 and θ2 are 90 degrees.

The unpurified pigment dispersion for preparation of inks is purified by using ultrapure water as an extracting liquid at a flow rate of the unpurified pigment dispersion and ultrapure water of 10 ml/h, to give a purified pigment dispersion for preparation of inks.

After purification, the conductivity of the ultrapure water in an extracting liquid recover unit is found to be greater than that of the ultrapure water in the extracting liquid supplying unit side, indicating that the impurities are removed by the purification treatment.

Then, glycerol, diethylene glycol monobutylether, Olfine E1010 (manufactured by NISSIN CHEMICAL INDUSTRY CO., LTD), and pure water are added to the pigment dispersion for preparation of inks obtained after the purification treatment, to give an ink having the following composition. Glycerol, diethylene glycol monobutylether, and Olfine E1010 (manufactured by NISSIN CHEMICAL INDUSTRY CO., LTD) used are commercial products previously purified (respectively, analytical grade), and pure water used is also previously filtered through a filter having an opening of 0.45 μm.
Pigment: 5% by weight
Glycerol: 10% by weight
Diethylene glycol monobutylether: 3% by weight
Olefin E1010
   (manufactured by NISSIN CHEMICAL INDUSTRY CO., LTD): 1% by weight
Pure water: balance

### Example 2

6 parts by weight of a neutral alkali metal salt of styrene-methacrylic acid copolymer (weight-average molecular weight: 30,000, acid value: 200 mg-KOH/g, neutralization degree: 0.4, NaOH used for neutralization) and additionally ion-exchange water are added to 30 parts by weight of carbon black (Mogul L, manufactured by Cabot Corporation), to be made the total amount of 300 parts by weight. The solution is ultrasonicated in an ultrasonic wave homogenizer, allowing the pigment to be dispersed. Then, the dispersion is centrifuged in a centrifugation, and the residue (100 parts by weight) is removed. A small amount of the dispersion is collected and dried; and after determining the pigment content by using a simultaneous differential thermal and thermogravimetric analyzer (EXSTAR6000 TG/DTA, manufactured by SII Nano Technology Inc.), the dispersion is diluted with ion-exchange water, to give an unpurified pigment dispersion for preparation of ink having a pigment concentration of 10% by weight.

Then, the unpurified pigment dispersion for preparation of inks obtained is subjected to filter filtration and ion exchange treatment in a similar manner to Example 1, and the unpurified pigment dispersion for preparation of inks is purified in a similar manner to Example 1 by using an apparatus for purifying a pigment dispersion having the configuration shown in FIG. 1.

After purification, the conductivity of the ultrapure water in the extracting liquid recover unit is found to be greater than that of the ultrapure water in the extracting liquid supplying unit side, indicating that the impurities are removed by the purification treatment. Then, other components are added to give an ink having composition similar to that of the ink in Example 1.

### Example 3

An unpurified pigment dispersion for preparation of inks obtained in a similar manner to Example 2 is subjected previously to filter filtration and ion exchange treatment, and then, purified by using toluene (purity: 99.5% or more, manufactured by Wako Pure Chemical Industries, analytical grade) instead of ultrapure water as an extracting liquid in a similar manner to Example 1 using an apparatus for purifying the pigment dispersion in the configuration shown in FIG. 1.

After purification, absorption spectra of the toluene samples in the extracting liquid supplying unit and the extracting liquid recover unit are obtained, and the results show that only peaks of toluene are observed in toluene in the extracting liquid supplying unit, while peaks not derived from toluene are observed in the toluene in the extracting liquid recover unit, although the peak is small, indicating that the impurities are removed by the purification treatment.

Subsequently, other components are added, to give an ink having a composition similar to that of the ink in Example 1.

### Example 4

An unpurified pigment dispersion for preparation of inks obtained in a similar manner to Example 2 is subjected previously to filter filtration and ion exchange treatment, and purified by an apparatus for purifying a pigment dispersion having the configuration shown in FIG. 2. In the purifying apparatus used, the first channel 110 and the second channel 120 have a square cross-sectional shape of 0.1 mm in height and 0.1 mm in width; each of the confluent zones 130A and 130B has a rectangular cross-sectional shape of 0.1 mm in height and 0.2 mm in width and a length of 400 mm; and the angles θ1 and θ2 are 90 degrees.

The unpurified pigment dispersion is purified by supplying ultrapure water as a first extracting liquid into the second channel 120A at a flow rate of 10 ml/h, and toluene used in Example 3 as a second extracting liquid into the second channel 120B at a flow rate of 10 ml/h, and the unpurified pigment dispersion for preparation of inks into the first channel 110 at a flow rate of 10 ml/h, to give a purified pigment dispersion for preparation of inks.

After purification, the conductivity of the ultrapure water in the ultrapure water recover unit is determined, demonstrating that it is higher than that of the ultrapure water in the ultrapure water supplying unit side. Analysis of the spectra of the toluene samples in the toluene supplying unit and the toluene recover unit reveals that the toluene in the extracting liquid supplying unit has only peaks derived from toluene, while the toluene in the extracting liquid recover unit has peaks derived from compounds other than toluene, although the intensity is smaller, indicating that the impurities are removed by the purification treatment.

Subsequently, other components are added, to give an ink having a composition similar to that of the ink shown in Example 1.

### Comparative Example 1

An ink is prepared in a similar manner to Example 1, except that the purification treatment using the apparatus for purifying a pigment dispersion shown in FIG. 1 as in Example 1 is not performed.

### Comparative Example 2

An ink is prepared in a similar manner to Example 2, except that the purification treatment using the apparatus for purifying a pigment dispersion shown in FIG. 1 as in Example 2 is not performed.

(Evaluation)

The ejection efficiency and the storage stability of each of the inks obtained in the Examples and Comparative Examples during ink-jet recording are evaluated. Results are summarized in Table 1.

TABLE 1

| | Ejection efficiency | Storage stability |
|---|---|---|
| Example 1 | A | A |
| Example 2 | A | A |
| Example 3 | A | A |
| Example 4 | A | A |
| Comparative Example 1 | B | A |
| Comparative Example 2 | B | B |

Evaluation method and evaluation criteria for the ejection efficiency and the storage stability shown in Table 1 are as follows:

-Ejection Efficiency-

A one-dot line is printed continuously on 500 FX-P paper (manufactured by Fuji Xerox: A4 size) by using an inkjet-recording apparatus equipped a prototype recording head having 256 nozzles and having a definition of 800 dpi (manufactured by Fuji Xerox); and the line in the sample printed on approximately cumulative 500th paper is examined by visual observation, to determine whether the dots constituting the line are on a straight line (or whether there is bent). The evaluation criteria are as follows:

A: There is no bent observed at all dots.

B: There are bents observed at some dots.

-Storage Stability-

Each of the inks is left at 70° C. for one month under a tightly sealed condition, and the change in viscosity between before and after storage is examined.

A: Viscosity change: less than 10%

B: Viscosity change: 10% or more

As described above, the invention provides a method and an apparatus for purifying a pigment dispersion by removing impurities that could not be removed by conventional purification treatments, which are contained in the pigment dispersion such as the pigment dispersion for the production of ink, ink and the like; a pigment dispersion and an ink set using the same; and a droplet-ejecting apparatus and an inkjet-recording ink tank using the ink prepared by employing the pigment dispersion.

All publications, patent applications, and technical standards mentioned in this specification are herein incorporated by reference to the same extent as if each individual publication, patent application, or technical standard was specifically and individually indicated to be incorporated by reference.

What is claimed is:

1. A method of purifying a pigment dispersion, comprising:
bringing an unpurified pigment dispersion containing a pigment and impurities into liquid-liquid interfacial contact with an extracting liquid in a microspace, and
extracting and removing the impurities in the unpurified pigment dispersion into the extracting liquid to obtain a purified pigment dispersion.

2. The method of purifying a pigment dispersion of claim 1, wherein the pigment is a self-dispersible pigment.

3. The method of purifying a pigment dispersion of claim 1, wherein the unpurified pigment dispersion comprises a dispersant for a pigment.

4. The method of purifying a pigment dispersion of claim 1, wherein an apparatus for purifying a pigment dispersion which comprises at least a first channel, a second channel, and a confluent zone in which a region of the first channel and a region of the second channel are connected to each other and a liquid stream in the first channel and a liquid stream in the second channel flow in a state of liquid-liquid interfacial contact with each other is used, and
the unpurified pigment dispersion is supplied to the first channel at an upstream side of the confluent zone and the extracting liquid is supplied to the second channel at an upstream side of the confluent zone.

5. A pigment dispersion, prepared by the purifying method of claim 1.

6. An ink set comprising inks of two or more colors including a black ink, wherein the inks are prepared with a pigment dispersion obtained by the purifying method of claim 1.

7. A droplet-ejecting apparatus, which comprises at least a droplet-ejecting unit that ejects droplets, and which forms an image by ejecting ink droplets onto a surface of a recoding medium from the droplet-ejecting unit, wherein the ink is prepared by using a pigment dispersion prepared by the purifying method of claim 1.

8. An inkjet-recording ink tank, which is detachably connected to an inkjet-recording apparatus having a recording head, stores an ink prepared by using a pigment dispersion prepared by the purifying method of claim 1, and supplies the ink to the recording head in a state of being connected to the inkjet-recording apparatus.

9. An apparatus for purifying a pigment dispersion comprising:
a purifying unit in which an unpurified pigment dispersion containing a pigment and impurities is brought into liquid-liquid interfacial contact with an extracting liquid in a microspace and the impurities in the unpurified pigment dispersion are extracted into the extracting liquid to remove the impurities,
an unpurified pigment dispersion supplying unit that introduces the unpurified pigment dispersion,
an extracting liquid supplying unit that introduces the extracting liquid,
a pigment dispersion recovery unit that collects the pigment dispersion purified by the purifying unit, and
an extracting liquid recovery unit that collects the extracting liquid containing the extracted impurities from the purifying unit.

10. An apparatus for purifying a pigment dispersion comprising:
a purifying unit which comprises a first channel, a second channel, and a confluent zone in which a region of the first channel and a region of the second channel are connected to each other and a liquid stream in the first channel and a liquid stream in the second channel flow in a state of liquid-liquid interfacial contact,
an unpurified pigment dispersion supplying unit that introduces an unpurified pigment dispersion containing a pigment and impurities into the first channel and that is connected thereto at an upstream side of the confluent zone,
an extracting liquid supplying unit that introduces the extracting liquid into the second channel and that is connected thereto at an upstream side of the confluent zone,
a pigment dispersion recovery unit that collects the pigment dispersion purified by the purifying unit and that is connected to the first channel at a downstream side of the confluent zone, and
an extracting liquid recovery unit that collects the extracting liquid containing extracted impurities, from the purifying unit, and that is connected to the second channel at a downstream side of the confluent zone.

11. The apparatus for purifying a pigment dispersion of claim 9, wherein a plurality of the purifying units are provided and are arranged in parallel or in series.

12. The apparatus for purifying a pigment dispersion of claim 10, wherein a plurality of the purifying units are provided and are arranged in parallel or in series.

13. The apparatus for purifying a pigment dispersion of claim 9, wherein the pigment is a self-dispersible pigment.

14. The apparatus for purifying a pigment dispersion of claim 10, wherein the pigment is a self-dispersible pigment.

15. The apparatus for purifying a pigment dispersion of claim 9, wherein the unpurified pigment dispersion includes a dispersant for the pigment.

16. The apparatus for purifying a pigment dispersion of claim 10, wherein the unpurified pigment dispersion includes a dispersant for the pigment.

17. The apparatus for purifying a pigment dispersion of claim 9, wherein the unpurified pigment dispersion and the extracting liquid form a laminar flow in the confluent zone.

18. The apparatus for purifying a pigment dispersion of claim 10, wherein the unpurified pigment dispersion and the extracting liquid form a laminar flow in the confluent zone.

19. The apparatus for purifying a pigment dispersion of claim 9, further comprising a filter and/or a unit that remove(s) particles and/or ionic contamination in the pigment dispersion and that is provided between the upstream side of the first channel and the unpurified pigment dispersion supplying unit that introduces the pigment dispersion.

20. The apparatus for purifying a pigment dispersion of claim 10, further comprising a filter and/or a unit that remove(s) particles and/or ionic contamination in the pigment dispersion and that is provided between the upstream side of the first channel and the unpurified pigment dispersion supplying unit that introduces the pigment dispersion.
